(19) United States
(12) Patent Application Publication
(10) Pub. No.: US 2002/0191400 A1
(43) Pub. Date: Dec. 19, 2002

(54) Direct/indirect task lighting

(76) Inventors: Larry M. Jilk, Apple Valley, MN (US); Gary M. Tushie, Lakeville, MN (US)

Correspondence Address: WESTMAN, CHAMPLIN & KELLY, INTERNATIONAL CENTRE - SUITE 1600, 900 SECOND AVENUE SOUTH, MINNEAPOLIS, MN, 55402-3319, US

(21) Appl. No.: 09/880,718

(22) Filed: Jun. 13, 2001

(51) Int. Cl. F21S 2/00

(52) U.S. Cl. 362/257

(57) ABSTRACT

A direct/indirect task light for use in connection with office work stations has an elongated light source, preferably a fluorescent bulb as the source. The light source has a housing that is imperforate, but has an opening directed toward an overlying canopy that forms a reflector for the light. The canopy has perforations or apertures therethrough so that light will pass through the perforations to the exterior to provide ambient lighting. Light striking the canopy surface between apertures will be reflected from the lower surface of the canopy onto an office work surface.

### BACKGROUND OF THE INVENTION

The present invention relates to a lighting system used in connection with office work stations that provides a light that provides both direct and indirect lighting. A canopy is provided over the lamp or light source, with a number of perforations through the canopy that permit light to be transmitted outwardly from the canopy as well as reflecting from the surface of the canopy facing the light source.

Eye strain caused by glare from lights has been recognized as a source of discomfort. Eye strain can cause lack of energy, loss of productivity, decline in mental sharpness, and even muscular and skeletal injuries. Direct lighting has long been used in work places to light work surfaces, but this causes harsh glares, and also reflections when computer screens are used. Direct lighting makes it difficult for the eyes of workers to adjust, as the eyes move from a white paper, to a computer screen and to glossy magazines, for example.

A recent trend in lighting at the work place has been away from direct lighting to a combination of ambient lighting and task lighting. Ambient lighting is used to illuminate the overall work environment, and task lighting is used to decrease shadows under heightened storage. Task lighting also provides additional light for work requiring higher light levels.

Individually controlled task lighting in addition to ambient light will direct the light onto a work surface, and by angling the light or otherwise adjusting the light, enough illumination can be provided to a work area or top while glare is minimized.

Direct/indirect lighting is mixed from direct sources and indirect reflection, and means that different types of luminaries or lamp housings are installed. The luminaries emit light both up to the ceiling and down to the work area. A balance of ambient illumination and accent or focus lighting can be provided in addition to having energy efficiency and control over reflective glares.

Direct lighting is directly from a source but is not reflected from other surfaces. Typically direct lighting refers to ceiling mounted or suspended luminaries with light distributed chiefly downwardly. Standard, under cabinet mounted task lights fall in the direct lighting category. Direct lighting can be very energy efficient and effective but it does leave the ceilings fairly dark creating “cave-like” environments and often causes reflected glare on computer screens, desk surfaces and glossy paper.

Indirect lighting is created by reflection off the walls or ceiling surfaces. Luminaries are work station mounted, wall mounted or suspended from the ceiling and disperse light upwardly to be reflected toward work areas off the ceiling and walls. This does create a soft undisturbing atmosphere appropriate for concentrated work although it does become disconcerting if the ceiling is the brightest surface in the room. In addition, indirect lighting is not as energy efficient as other types of lighting, and controlling brightness or the degree of illumination can be a problem.

### SUMMARY OF THE INVENTION

The present invention relates to a direct/indirect combination of lights in a light assembly used as task lights or work space lights, without uncomfortable glare and reflection. A comfortable balance of indirect yet focused light is provided. The light assembly includes a canopy or overlying wall surface with perforations that emit light outwardly to provide an ambient illumination in the room. The under surface of the canopy wall is made reflective, so that it will reflect light down onto a work top in the work station, or in the area where computer operations, reading or other office work is taking place.

The present lighting system or light assembly has a light source used in combination with the canopy, with the light source mounted below the canopy but directing light upwardly toward the canopy. Preferably the light source is an energy efficient fluorescent lamp, that is mounted in an imperforate, open top reflective housing that does not permit any direct light to be radiated down on the work top. All of the light is directed or reflected up to the underside of the canopy. Suitable reflectors can be used around the fluorescent lamp.

The perforations of the canopy are formed so that they are relatively small, and preferably, but not necessarily, evenly spaced to provide an open area of approximately 10-15% of the area of the canopy wall. This permits lines of light that directly emanate out the openings or apertures of the canopy upwardly. Ambient lighting in the environment of the work station is thus provided. The undersurface of the canopy is made reflective, generally using a white reflective surface that will tend to focus the indirect light onto the work top or work station below the light.

The light canopy and light source are mounted as a unit, and will fit well onto uprights used for work station panels, or are easily adapted to any type of mounting. They can be provided in widths that are varied according to the needs of the work station area, and easily powered from regular power sources.

### BRIEF DESCRIPTION OF THE DRAWINGS

FIG. 1 is a perspective view of a typical work station utilizing a direct/indirect light assembly made according to the present invention;

FIG. 2 is an enlarged perspective view from the underside of a canopy of a light assembly showing a light source in position;

FIG. 3 is a bottom perspective view of a double sided canopy using the direct/indirect lighting assembly of the present invention;

FIG. 4 is a perspective view of a single canopy for one side of a work station panel made according to the present invention with parts broken away to show a supporting frame;

FIG. 5 is a perspective view of a double canopy made according to the present invention with parts broken away to show a supporting frame;

FIG. 6 is a side elevational view of a single sided canopy showing the mounting frame and light source in position; and

FIG. 7 is an enlarged side view of a hinge support for the light housing; and

FIG. 8 is a sectional view taken on line 8-8 in FIG. 7.

### DETAILED DESCRIPTION OF THE PREFERRED EMBODIMENTS

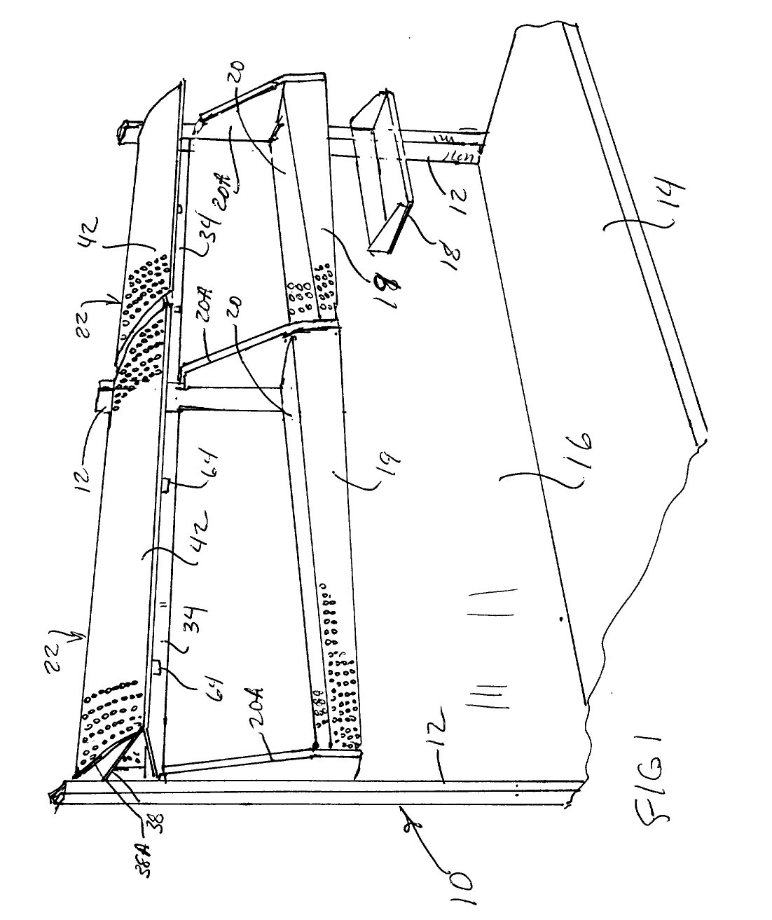

Referring to FIG. 1, a work station or work area indicated generally at 10 comprises a series of upright supports 12, that support a work top or surface 14, and divider panels 16 extending between the uprights 12. The panels 16 can support bins or hoppers 18 for holding papers or the like, and suitable shelves 20 also can be supported onto the upright 12 in a normal manner with brackets 20A. The shelve can be perforated as shown and can be inclined, with tapered front panels 19.

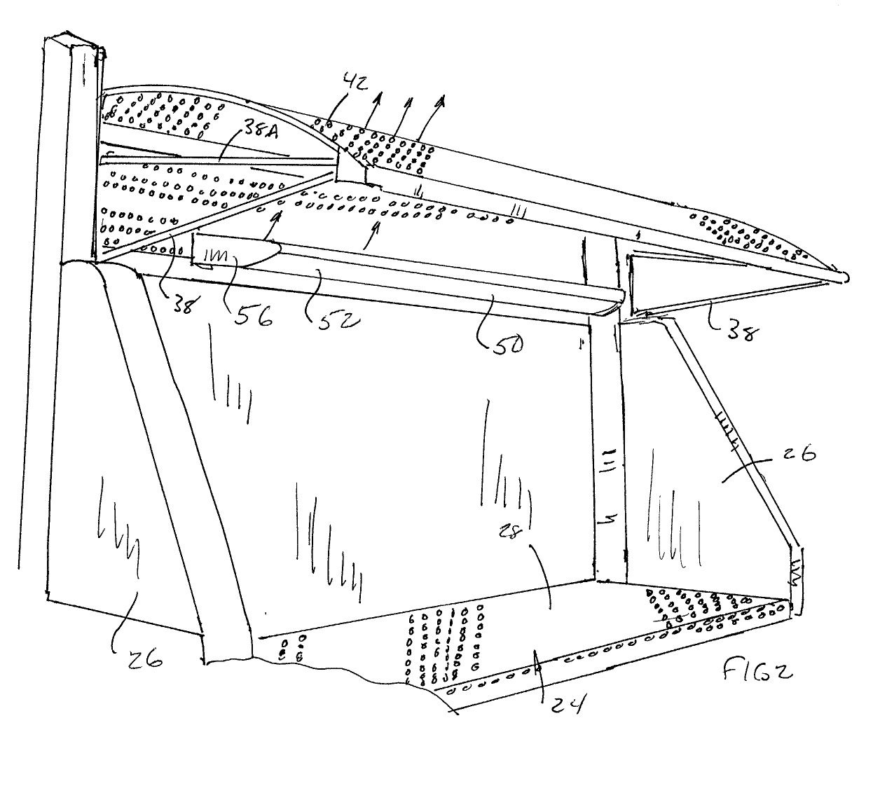

In order to light the work surface 14, without glare, and yet provide ambient light, light assemblies 22 made according to the present invention are supported on the uprights in a suitable manner, such as with retainer hooks or the like. Light assemblies 22 as shown in FIGS. 1 and 2 can be directed toward one side of the work station. In FIG. 2, different shelves 24 are shown, with side panels 26 and a shelf member 28 that is perforated so that it also will let light shine directly below the shelves if desired.

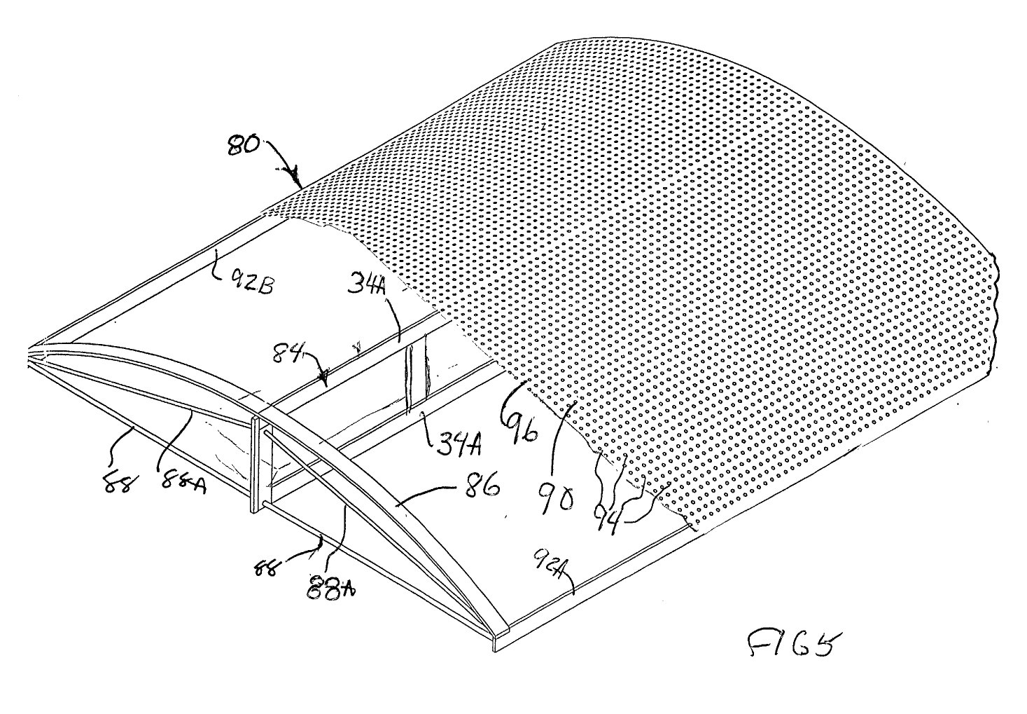

The light assembly 22 has a framework 30, which is shown in greater detail in FIG. 4, and also in FIG. 6. The framework 30 is a cantilevered type framework that has a back frame with upright end members 32, that are adapted to be supported on uprights 12, or on other support members. The upright end members 32 are joined with longitudinal stringers 34 that are spaced apart in a vertical direction. The upright end members 32 and stringers 34 form a base frame section 35. Outwardly extending canopy support stringers 36 are attached to ends of the upper one of the cross members 34, at the upper end of the upright end members 32. The canopy support stringers are attached as arcs and are supported with a bridging or bracing rod 38 and a tension carrying cable 38A in a suitable manner. The rod 38 and cable 38A are fixed to the uprights 32 of base frame section 35 and connect to the outer ends of the canopy support stringers. A front cross member 40 is also provided between the outer end of the canopy support stringers 36 to provide the frame assembly 30.

A canopy shown at 42 is made to be supported on the stringers 36, and fold over the upper one of the cross members 34, so that it extends down on the back side of the cross members 34. A portion of the back wall is shown at 44, in FIG. 4.

The canopy 42 is made of a suitable sheet material, such as a metal or other material that is desired, and is of size to span the open spaces of the frame 30. The canopy 42 is formed in an arc, so it is part cylindrical, about a longitudinal axis that extends along the width of the workstation. The arc of canopy 42 is less than 90°.

An under surface 46 of the canopy 42, as seen in FIG. 2, is white, and is a light reflective surface. The canopy 42 is perforated with numerous holes or perforations 48, that are of size to let small diameter shafts of light through. The apertures are preferably evenly across the entire canopy area to provide for approximately 30% to 40% open area on the canopy 42. That means that shafts of light that are indicated by rays in FIG. 4 for example will go upwardly into the office space, and reflect off the walls and ceiling, to provide for ambient lighting that is essentially “filtered.” It does not cause glare or high density reflections. The light that is reflected off the interior surface 46 of the canopy, is reflected down onto the work surface or work top 14, as indirect light, to provide a low glare soft lighting for the work area which normally will be covered with paper, usually white. Additionally, if a computer screen is used, the reflected lighting from the canopy is not a high glare light that would reflect directly from the computer screen. The apertures 48 are not all shown in the drawings, but would be provided in the entire canopy wall.

The frame 30 hingedly supports a lamp or light housing 50, which, as shown, has an imperforate (solid) wall 52 that is on the lower side of the light housing 50, and has a vertical or upright wall 54 that is also imperforate, that extends along the plane of the frame cross members 34, and is positioned on the inside of the panel 44 of the canopy. The light housing 50 has end walls 56 that support fittings 58 for receiving a fluorescent light tube, shown schematically at 60. The light housing 50 is mounted onto the lower cross member 34 with suitable hinges 64, shown in FIGS. 6, 7 and 8 to permit adjusting the light housing 50, as shown in dotted lines in FIG. 6. The hinge members 64 include a “Z” shaped bracket 65 having one leg 66 has one leg 66 secured to the lower frame member 34 in a suitable manner, such as with screws or rivets or other fasteners. The bracket 65 has a second leg 67 that extends at right angles to the leg or wall 66 and a third leg 68 that is tapered outwardly toward the top and is perpendicular to leg 66. A hinge or pivot bracket 69 is “L” shaped and has one leg 69A adjacent to and pivoted to the leg 67 of the bracket 65 with a pin 70. The pin 70 forms a hinge axis parallel to the axis of the canopy arc. The bracket 69 also has a leg 69B perpendicular to leg 69A and in alignment with the leg 68 of bracket 65.

The leg 69B is mounted to the rear wall of the light housing 50 in a suitable manner, for example with a bracket 70C, that is only schematically shown.

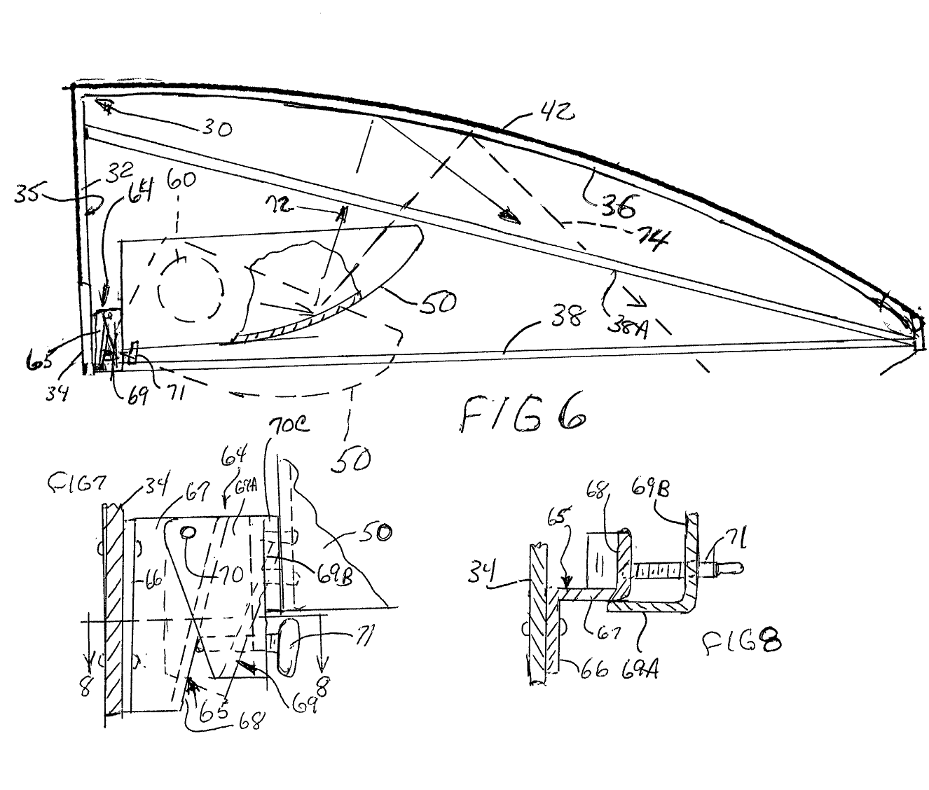

As shown schematically in FIGS. 6, 7 and 8 an adjustment thumbscrew 71 can be used between the pivot bracket 69 and the bracket 65 to permit adjusting the angle of the light housing about the hinge axis. The screw 71 is threaded through a hole in the pivot bracket leg 69B. By turning the screw 71 the pivot or hinge bracket and the light housing 50 can be adjusted at a selected angle from a starting position shown in dotted lines in FIGS. 6 and 7 upwardly to the solid line position shown. The thumbscrew at each hinge can be adjusted to change the angle of the light housing. Other forms of adjustable pivots or angle adjustment connections can be used.

Changing the angle of the light housing 50 will change the angle of incidence of light coming from the fluorescent tube 60 as shown in FIG. 6. Adjusting the angle of the light housing relative to the canopy 42 can change the focus of light coming from the fluorescent tube 60.

These light paths are illustrated schematically at 72 and 74, respectively, to show the different paths that the light can take.

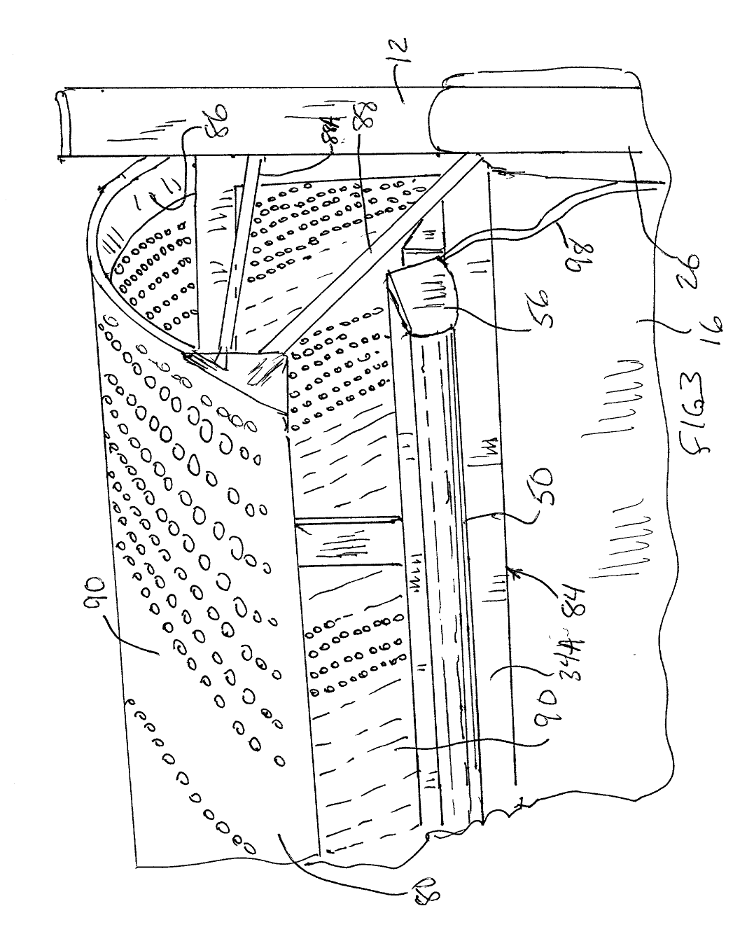

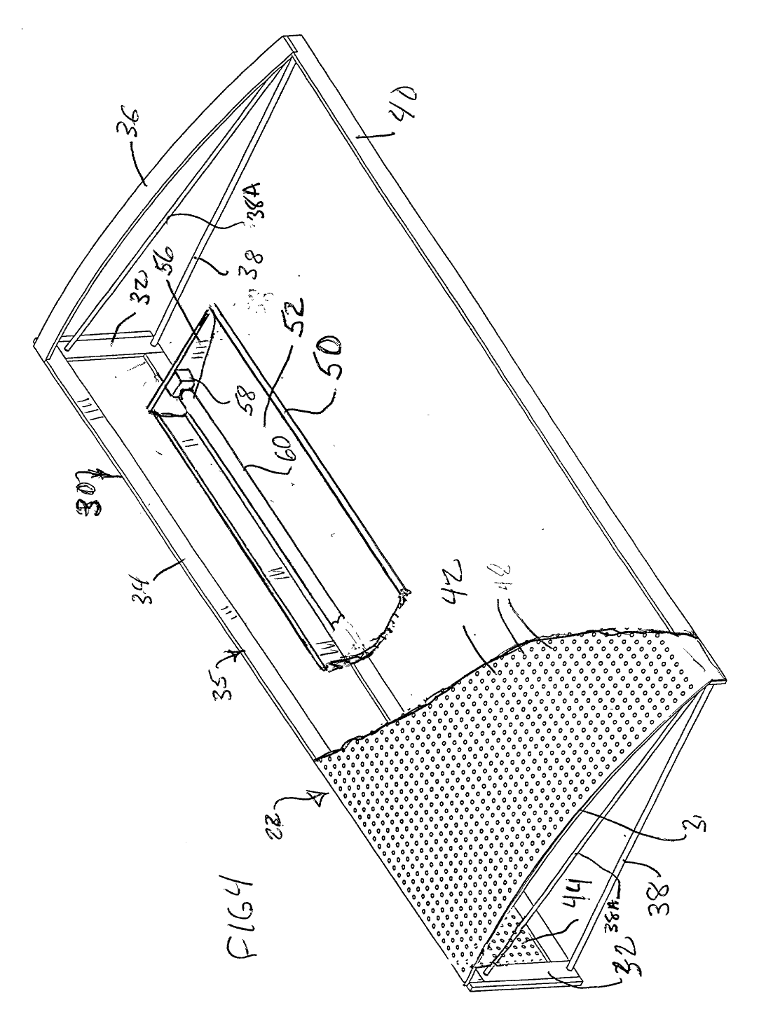

The double side canopy light assembly 80 shown in FIGS. 3 and 5, is constructed in substantially the same way. The light 80 has frame 82 that uses a center frame member 84 comprising transversely extending members 34A, which are substantially the same as that shown at 34 in FIG. 4. In this case, the end stringers 86 extend in both directions from the center frame 84. The stringers 86 form arcs extending in the two opposite directions from the center. The stringers 86 are suitably supported with a brace 88 and a cable 88A back to the center frame 84. The stringers are connected together with transverse members 92 at each end.

The light assembly 80 has a perforated canopy panel 90, which as shown extends from one end transversely extending member 92A across the frame 84 to the second transversely extending member 92B. This double frame can be mounted where there are double (back to back) work stations, or where there is a similar need for lights on both sides of a divider. The canopy panel 90 is made in the same manner as the canopy panel 42, and is perforated with apertures 94 formed through the panel. The underside surface 96 of the canopy panel 90 is again reflective, and the perforations or aperture 94 permit shafts of light to pass out as previously described.

The canopy panel is formed in an arc matching the arc of stringers 86 about a central axis. The arc of the double canopy is a total greater than 90°, and it extends equal amounts on opposite sides of the plane of center frame member or base frame section 84.

When the light assembly is used, as can be seen in FIG. 3, there will be lamp housings on both sides of the center dividing frame 84. The lamp housings are supported on the lower frame members 34A, with hinges as shown in FIG. 6.

The two lamp or light housings can be seen in FIG. 3. The lights will be connected with suitable electric lines 98, and of course suitable switches can be provided as well. The double sided light assembly having the larger canopy 90, can be suspended from the ceiling if desired to provide the light patterns and reflected light as described in a room area.

It has been found that apertures or holes are preferably in the range of 3/16 of an inch and can range between ⅛ and ¼ inches in diameter, with 3/16 diameter apertures, a spacing of about ½ an inch has been adequate. The spacing can vary between ⅜ to ⅝ inches, and is preferably just over twice the aperture diameter. The curve or radius of the arc of the canopies can be adjusted as desired, but a radius in the range of 33 inches has been found to be adequate.

While the illustrations do not show the apertures or openings in the canopy panels throughout the entire surface, it is to be understood that the entire surface of the canopy panels that receive light will be provided with the openings or apertures to permit light to pass through.

The canopies can be made of any desired material, but thin metal that is coated suitably with a reflective coating on the underside, and then painted or coated with the desired color on the top side works satisfactorily. The apertures extend through the material of the canopy. The arc shaped reflective surface permits better reflection and focusing of the reflected light onto the work station.

It can also be noted that any type of an adjustable hinge can be used. The center pin can be adjusted for tightening the parts together, so that the load required for moving the hinge is increased and adjustment can be accomplished.

Although the present invention has been described with reference to preferred embodiments, workers skilled in the art will recognize that changes may be made in form and detail without departing from the spirit and scope of the invention.

What is claimed is:

1. A light assembly comprising a light source, and a canopy over the light source. The canopy receiving light radiation from the light source, said canopy being perforated to provide a plurality of apertures therethrough, of size to permit light to pass through the openings from one side of the canopy to the other, and a surface of the canopy facing the light source being reflective to reflect light from the surface toward a desired location.

2. The light assembly of claim 1, wherein said light assembly is a task light, said canopy being formed in an arc about a generally central axis that extends along a length of the canopy, the arc being formed along a radius from the central axis.

3. The light assembly of claim 1, and a frame for supporting said canopy, said frame having a base frame section at a desired location relative to the canopy and extending downwardly from the canopy, said light source being mounted on said base spaced from the canopy a desired amount.

4. The light assembly of claim 3, wherein said light source comprises an imperforate housing wall having an opening facing toward the canopy.

5. The light source of claim 4, wherein said imperforate housing wall is hingedly attached to the frame for the canopy about a hinge axis generally parallel to the longitudinal axis, and the housing being adjustable about the hinge axis to provide different angles for the light source housing relative to the canopy.

6. The light assembly of claim 3, wherein said canopy extends for a total arc of greater than 90° and extends in opposite directions from the base.

7. The light source of claim 3, wherein said canopy extends for an arc less than 90°, and has one edge along the base frame section.

8. The light assembly of claim 2, wherein said perforations on said canopy are evenly spaced on the canopy, and wherein the spacing between centers of the openings is greater than twice the diameter of the apertures.

9. The light source of claim 8, wherein said apertures range between ⅛ and ¼ inch in diameter.

10. The light source of claim 8, wherein said spacing between apertures ranges between ⅜ and ⅝ of an inch.

11. The light assembly of claim 2, wherein said surface of said canopy facing the light source is a white surface.

12. The light source of claim 2, used in combination with a work station having a work surface, said light source extending along a length of said work surface and being positioned above the work surface whereby reflected light from the canopy will strike the work surface in desired areas.

13. A combination with the work station having a work surface, and supports extending upwardly from the work surface, light assembly including light source, and a canopy supported over the light source relative to the work surface, the canopy receiving light radiation from the light source and being perforated to provide a plurality of apertures therethrough of size to permit light to pass through the openings from one side of the canopy to the other, a surface of the canopy facing the light source being reflective to reflect light from the canopy surface to the work surface.

14. A combination of claim 13, said supports comprise a generally upright panel extending upwardly from the work surface, the light source and canopy being supported on the side of the upright panel toward the work surface.

15. The combination of claim 14, wherein the supports comprise upright members along opposite sides of the surface, a frame for said light source and canopy, said frame being supported relative to the uprights.

16. The combination of claim 15, wherein said canopy is formed in an arc, and has light sources adjustably mounted for movement about a pivot axis generally parallel to an axis around the arc formation of the canopy.
